(19) United States
(12) Patent Application Publication
(10) Pub. No.: US 2024/0007139 A1
(43) Pub. Date: Jan. 4, 2024

(54) PHONE CASE WITH BUILT-IN SCREEN PROTECTOR

(71) Applicant: GUANGDONG SHENGZHEN TECHNOLOGY CO., LTD., DONGGUAN (CN)

(72) Inventor: KAIXUAN QIU, DONGGUAN (CN)

(21) Appl. No.: 17/892,265

(22) Filed: Aug. 22, 2022

(30) Foreign Application Priority Data
Jul. 1, 2022 (CN) 202221673110.0

(51) Int. Cl. H04B 1/3888; H04M 1/04

(52) U.S. Cl. CPC H04B 1/3888; H04M 1/04

(57) ABSTRACT

A phone case with a built-in screen protector includes a phone case front cover and a phone case back cover connected to the phone case front cover. A mobile phone body is wrapped between the phone case front cover and phone case back cover. The screen protector is embedded on the phone case front cover. The screen protector includes a flexible connecting layer and a tempered glass film layer arranged in sequence. The flexible connecting layer includes a fixed flexible connecting layer and an extending flexible connecting layer. The extending flexible connecting layer is arranged around an edge of the fixed flexible connecting layer. The fixed flexible connecting layer includes an acrylic adhesive layer, a transparent polyethyleneterephthalate (PET) substrate layer, and a silica gel adhesive layer. The acrylic adhesive layer is attached to a screen of the mobile phone body.

### TECHNICAL FIELD

The present disclosure relates to a technical field of phone cases, and in particular to a phone case with a built-in screen protector.

### BACKGROUND

A conventional mobile phone case and a conventional tempered glass screen protector are two independent products and are separated from each other. When a consumer wants to protect a mobile phone screen and a mobile phone body, the customer needs to buy a mobile phone case and a tempered glass screen protector separately and install the mobile phone case and the tempered glass screen protector separately.

Separate use of the phone case and the tempered glass screen protector is not only inconvenient, but also creates redundant packaging. In addition, because the mobile phone case and the tempered glass screen protector are two independent products, and specifications of the mobile phone case and tempered film produced by different manufacturers are different, compatibility between the mobile phone case and the tempered glass screen protector is not satisfactory. The most important thing is that one side of an AB glue layer of the tempered glass screen protector attached to the mobile phone screen is silica gel. The silica gel is configured for attachment. If the conventional tempered glass screen protector is directly connected to the conventional mobile phone case, the conventional tempered glass screen protector and the mobile phone screen cannot be completely fitted, which affects sensitivity of the mobile phone screen.

### SUMMARY

An object of the present disclosure is to provide a phone case with a built-in screen protector to solve a problem in the prior art that when a conventional tempered glass screen protector is directly connected to a conventional mobile phone case, the conventional tempered glass screen protector and the mobile phone screen cannot be completely fitted.

To achieve the above object, the present disclosure provides the phone case with the built-in screen protector. The phone case with the built0-in screen protector comprises a phone case front cover and a phone case back cover connected to the phone case front cover. A mobile phone body is wrapped between the phone case front cover and phone case back cover. The screen protector is embedded on the phone case front cover. The screen protector comprises a flexible connecting layer and a tempered glass film layer arranged in sequence. The flexible connecting layer comprises a fixed flexible connecting layer and an extending flexible connecting layer. The extending flexible connecting layer is arranged around an edge of the fixed flexible connecting layer. The fixed flexible connecting layer comprises an acrylic adhesive layer, a transparent polyethyleneterephthalate (PET) substrate layer, and a silica gel adhesive layer. The acrylic adhesive layer is attached to a screen of the mobile phone body.

Optically clear adhesive (OCA) is a special adhesive configured to bond transparent optical components (such as lenses, etc.). The OCA is colorless and transparent, has a light transmittance of over 95%, has good bonding strength, can be cured at room temperature or medium temperature, and has small curing shrinkage.

Silica gel, also known as silicic acid gel, is a highly active adsorption material. The silica gel is an amorphous substance with a chemical formula of mSiO2·nH2O. The silica gel does not react with any substance except strong alkali and hydrofluoric acid, is insoluble in water and any solvent, is non-toxic and tasteless, and is chemically stable.

Various types of silica gel form different microporous structures due to different manufacturing methods.

Chemical composition and a physical structure of the silica gel determine that the silica gel has many characteristics (such as high adsorption performance, good thermal stability, stable chemical properties, and high mechanical strength) that are difficult to be replaced by other similar materials.

PET film, also known as high temperature resistant polyester film, has excellent physical properties, chemical properties, and dimensional stability. The PET film is transparent, is recyclable, and is widely used in magnetic recording, photosensitive materials, electronics, electrical insulation, industrial films, packaging decoration, screen protection, optical-grade mirror surface protection, and other fields.

The tempered glass screen protector is configured to prevent the screen of the mobile phone body from shattering when the mobile phone body drops, rather than prevent scratches. An ordinary film has a hardness of 3H, and there will not be too many scratches on the ordinary film after a few months of use. The tempered glass screen protector has high hardness and low toughness, which is a reason to choose the tempered glass screen protector. When the mobile phone body drops, the tempered glass screen protector protects the screen from shattering.

Optionally, the extending flexible connecting layer comprises the acrylic adhesive layer, the transparent PET substrate layer, and the silica gel adhesive layer. The acrylic adhesive layer is bonded and fixed with the transparent PET substrate layer. The transparent PET substrate layer is bonded and fixed with the tempered glass film layer through the silica gel adhesive layer. The silica gel adhesive layer is bonded and fixed with the phone case front cover.

Optionally, the extending flexible connecting layer comprises the acrylic adhesive layer and the transparent PET substrate layer. The acrylic adhesive layer is bonded and fixed with the transparent PET substrate layer. The transparent PET substrate layer is bonded and fixed with the tempered glass film layer through the silica gel adhesive layer. The transparent PET substrate layer is bonded and fixed with and the phone case front cover through a dispensing layer.

Optionally, the extending flexible connecting layer comprises the transparent PET substrate layer. The transparent PET substrate layer is bonded and fixed with the tempered glass film layer through the silica gel adhesive layer. The transparent PET substrate layer and the phone case front cover are integrally injection-molded.

Optionally, the dispensing layer is made of AB glue material

The phone case front cover is covered on the tempered glass film layer, and there is a gap between an edge of the tempered glass film layer and the phone case front cover. The gap buffers connection between the tempered glass film layer and the phone case front cover to prevent the tempered glass film layer from lifting, generating air bubbles between the screen, cracking, etc.

Compared with the prior art, in the present disclosure, the phone case with the built-in screen protector is well sealed to prevent dust from entering.

The phone case with the built-in screen protector has a buffering effect through a flexible connection to prevent forming of the air bubbles between the screen protector and the screen.

### BRIEF DESCRIPTION OF DRAWINGS

FIG. 1 is a schematic diagram showing an overall structure of a phone case with a built-in screen protector of the present disclosure.

FIG. 2 is a front schematic diagram of a screen protector of the present disclosure.

FIG. 3 is a partial schematic diagram of the phone case with the built-in screen protector adopting an OCA bonding method.

FIG. 4 is an enlarged schematic diagram of area A shown in FIG. 3.

FIG. 5 is a partial schematic diagram of the phone case with the built-in screen protector adopting a PET dispensing method.

FIG. 6 is an enlarged schematic diagram of area B shown in FIG. 5.

FIG. 7 is a partial schematic diagram of the phone case with the built-in screen protector adopting an integrated PET method.

FIG. 8 is an enlarged schematic diagram of area C shown in FIG. 7.

In the drawings:
1—phone case front cover; 2—mobile phone body; 3—phone case back cover; 4—screen protector; 41—acrylic adhesive layer; 42—transparent PET substrate layer; 43—silica gel adhesive layer; 44—tempered glass film layer.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

### Embodiment 1

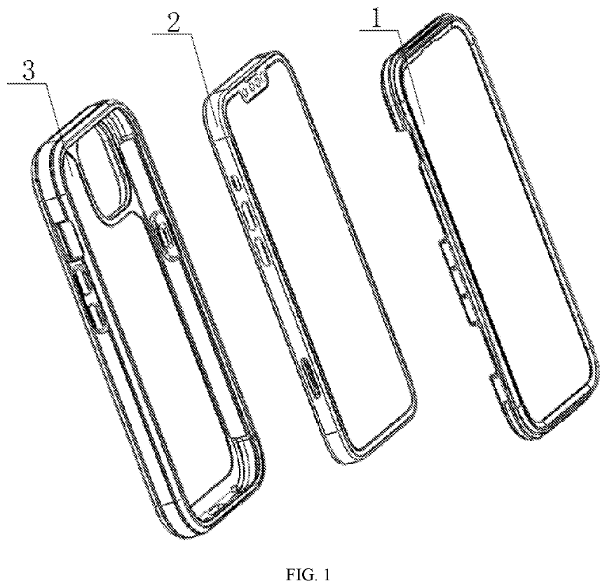

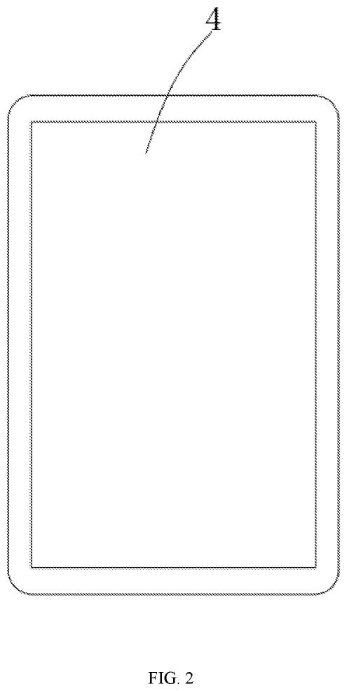

As shown in FIGS. 1-8, the present disclosure provides a phone case with a built-in screen protector. The phone case with the built0-in screen protector comprises a phone case front cover 1 and a phone case back cover 3 connected to the phone case front cover 1. A mobile phone body 2 is wrapped between the phone case front cover 1 and phone case back cover 3. The screen protector 4 is embedded on the phone case front cover 1. The screen protector comprises a flexible connecting layer and a tempered glass film layer 44 arranged in sequence. The flexible connecting layer comprises a fixed flexible connecting layer and an extending flexible connecting layer. The extending flexible connecting layer is arranged around an edge of the fixed flexible connecting layer. The fixed flexible connecting layer comprises an acrylic adhesive layer 41, a transparent polyethyleneterephthalate (PET) substrate layer 42, and a silica gel adhesive layer 43. The acrylic adhesive layer 41 is attached to a screen of the mobile phone body 2.

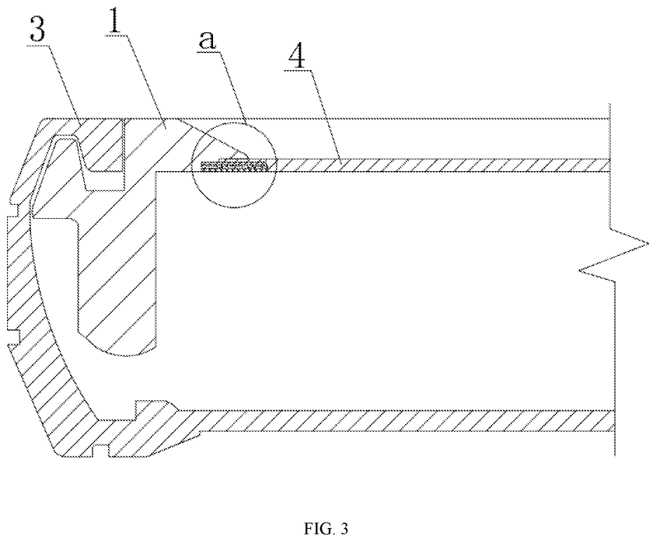

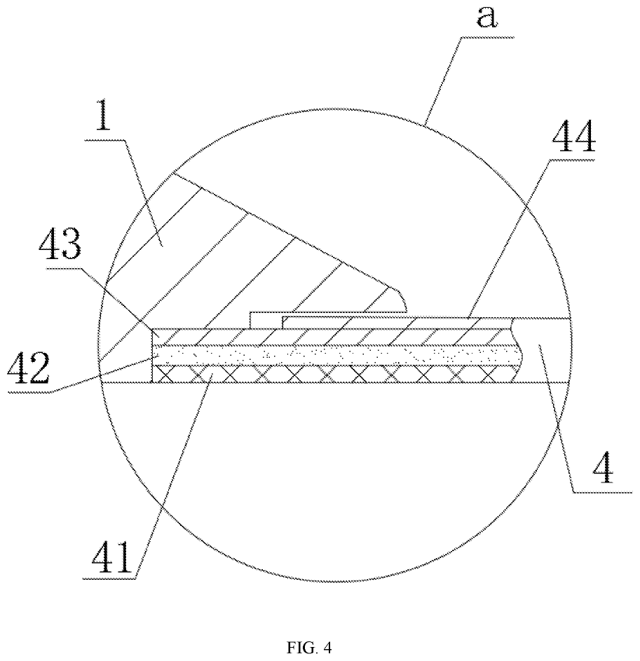

As shown in FIGS. 3 and 4, the extending flexible connecting layer comprises the acrylic adhesive layer 41, the transparent PET substrate layer 42, and the silica gel adhesive layer 43. The acrylic adhesive layer 41 is bonded and fixed with the transparent PET substrate layer 42. The transparent PET substrate layer 42 is bonded and fixed with the tempered glass film layer 44 through the silica gel adhesive layer 43. The silica gel adhesive layer 43 is bonded and fixed with the phone case front cover.

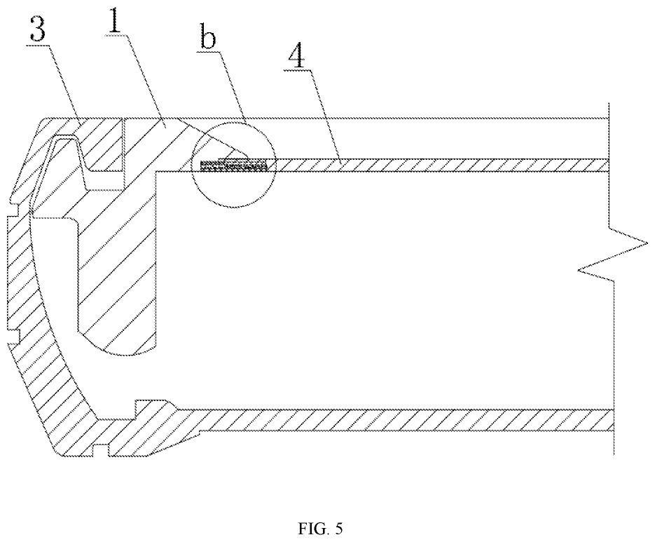

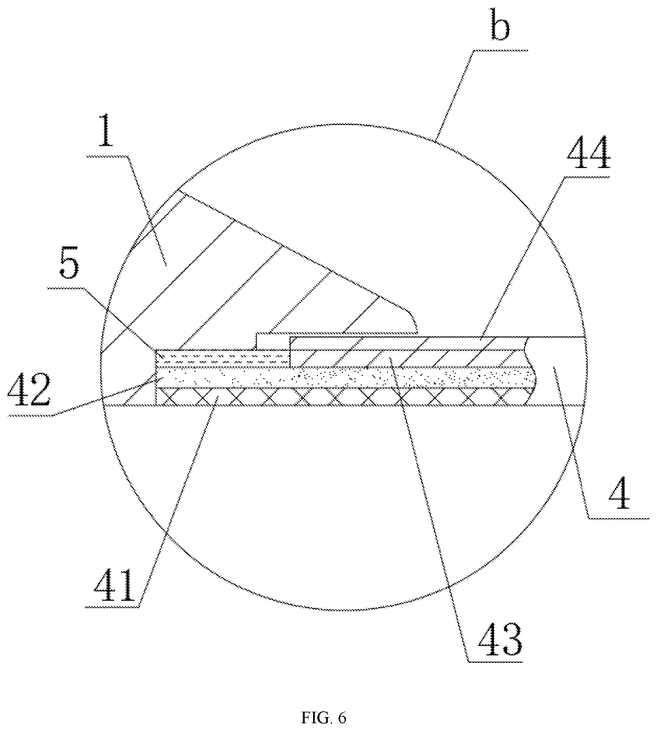

As shown in FIGS. 5 and 6, the extending flexible connecting layer comprises the acrylic adhesive layer 41 and the transparent PET substrate layer 42. The acrylic adhesive layer 41 is bonded and fixed with the transparent PET substrate layer 42. The transparent PET substrate layer 42 is bonded and fixed with the tempered glass film layer 44 through the silica gel adhesive layer 43. The transparent PET substrate layer 42 is bonded and fixed with and the phone case front cover 1 through a dispensing layer 5.

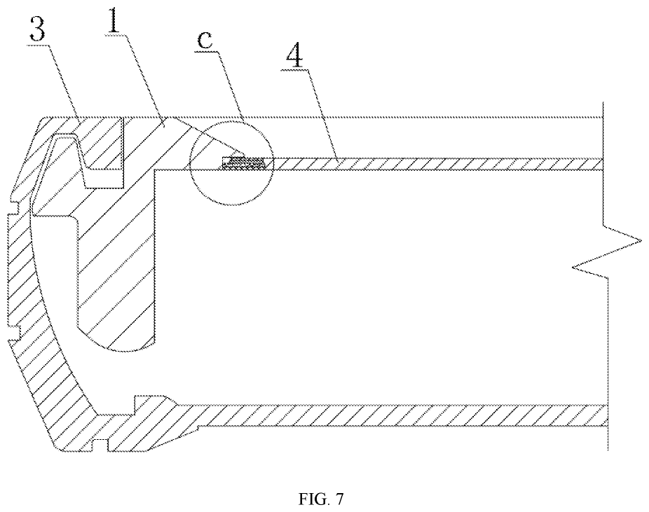

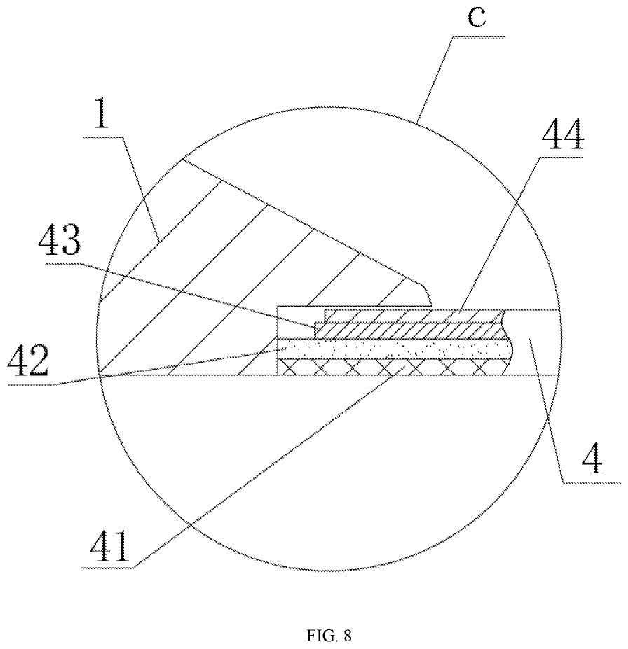

As shown in FIGS. 7 and 8, the extending flexible connecting layer comprises the transparent PET substrate layer 42. The transparent PET substrate layer 42 is bonded and fixed with the tempered glass film layer 44 through the silica gel adhesive layer 43. The transparent PET substrate layer 42 and the phone case front cover 1 are integrally injection-molded.

As shown in FIGS. 5 and 6, the dispensing layer 5 is made of AB glue material.

### Embodiment 2

As shown in FIGS. 3 and 4, the extending flexible connecting layer comprises the acrylic adhesive layer 41, the transparent PET substrate layer 42, and the silica gel adhesive layer 43. The acrylic adhesive layer 41 is bonded and fixed with the transparent PET substrate layer 42. The transparent PET substrate layer 42 is bonded and fixed with the tempered glass film layer 44 through the silica gel adhesive layer 43. The silica gel adhesive layer 43 is bonded and fixed with the phone case front cover.

When in use, the phone case with the built-in screen protector adopting an OCA bonding method. The tempered glass film layer 44 is fitted with a size of an inner wall of the phone case front cover 1 that is hollow. The acrylic adhesive layer 41, the transparent PET substrate layer 42, and the silica gel adhesive layer 43 of the fixed flexible connecting layer extend outward to form the extending flexible connecting layer, ensuring that the screen protector 4 is completely bonded with the phone case front cover 1 and making a connection stable.

### Embodiment 3

As shown in FIGS. 5 and 6, the extending flexible connecting layer comprises the acrylic adhesive layer 41 and the transparent PET substrate layer 42. The acrylic adhesive layer 41 is bonded and fixed with the transparent PET substrate layer 42. The transparent PET substrate layer 42 is bonded and fixed with the tempered glass film layer 44 through the silica gel adhesive layer 43. The transparent PET substrate layer 42 is bonded and fixed with and the phone case front cover 1 through a dispensing layer 5.

As shown in FIGS. 5 and 6, the dispensing layer 5 is made of AB glue material.

When in use, the phone case with the built-in screen protector adopting a PET dispensing method. The acrylic adhesive layer 41 and the transparent PET substrate layer 42 of the fixed flexible connecting layer extend outward to form the extending flexible connecting layer. By dispensing glue on a frame portion of the transparent PET substrate layer 42 (that is, the transparent PET substrate layer 42 of the extending flexible connecting layer), the transparent PET substrate layer 42 is bonded to the phone case front cover 1.

### Embodiment 4

As shown in FIGS. 7 and 8, the extending flexible connecting layer comprises the transparent PET substrate layer 42. The transparent PET substrate layer 42 is bonded and fixed with the tempered glass film layer 44 through the silica gel adhesive layer 43. The transparent PET substrate layer 42 and the phone case front cover 1 are integrally injection-molded.

When in use, the phone case with the built-in screen protector adopts an integrated PET method. The transparent PET substrate layer 42 of the fixed flexible connecting layer extend outward to form the extending flexible connecting layer.

The transparent PET substrate layer 42 and the phone case front cover 1 are integrally formed by injection molding. Then the acrylic adhesive layer 41 are bonded with a first side of the transparent PET substrate layer 42, and the silica gel adhesive layer 43 is bonded with a second side of the transparent PET substrate layer 42. Finally, the tempered glass film layer 44 is bonded with the silica gel adhesive layer 43 to form the screen protector 4.

It should be noted that, in the present disclosure, relational terms, such as “first” and “second”, are only used to distinguish one feature or operation from another feature or operation, and do not necessarily require or imply any actual relationship or sequence exists between these features or operations. Moreover, terms “comprise”, “include” or any other variation thereof are intended to encompass non-exclusive inclusion, such that a process, method, article or device not only comprises elements explicitly listed, but also comprises elements not explicitly listed or other elements inherent to such a process, method, article or device.

Although the embodiments of the present disclosure have been shown and described, those of ordinary skill in the art can understand that various changes, modifications, substitutions, and variations can be made to these embodiments without departing from the principle and spirit of the present disclosure. The scope of the present disclosure is defined by the attached claims and their equivalents.

What is claimed is:

1. A phone case with a built-in screen protector, comprising:
a phone case front cover; and
a phone case back cover connected to the phone case front cover;
wherein a mobile phone body is wrapped between the phone case front cover and phone case back cover; the screen protector is embedded on the phone case front cover; the screen protector comprises a flexible connecting layer and a tempered glass film layer arranged in sequence; the flexible connecting layer comprises a fixed flexible connecting layer and an extending flexible connecting layer; the extending flexible connecting layer is arranged around an edge of the fixed flexible connecting layer; the fixed flexible connecting layer comprises an acrylic adhesive layer, a transparent polyethyleneterephthalate (PET) substrate layer, and a silica gel adhesive layer; the acrylic adhesive layer is attached to a screen of the mobile phone body.

2. The phone case with the built-in screen protector according to claim 1, wherein the extending flexible connecting layer comprises the acrylic adhesive layer, the transparent PET substrate layer, and the silica gel adhesive layer; the acrylic adhesive layer is bonded and fixed with the transparent PET substrate layer; and the transparent PET substrate layer is bonded and fixed with the tempered glass film layer through the silica gel adhesive layer; the silica gel adhesive layer is bonded and fixed with the phone case front cover.

3. The phone case with the built-in screen protector according to claim 1, wherein the extending flexible connecting layer comprises the acrylic adhesive layer and the transparent PET substrate layer; the acrylic adhesive layer is bonded and fixed with the transparent PET substrate layer; the transparent PET substrate layer is bonded and fixed with the tempered glass film layer through the silica gel adhesive layer; the transparent PET substrate layer is bonded and fixed with and the phone case front cover through a dispensing layer.

4. The phone case with the built-in screen protector according to claim 1, wherein the extending flexible connecting layer comprises the transparent PET substrate layer; the transparent PET substrate layer is bonded and fixed with the tempered glass film layer through the silica gel adhesive layer; the transparent PET substrate layer and the phone case front cover are integrally injection-molded.

5. The phone case with the built-in screen protector according to claim 3, wherein the dispensing layer is made of AB glue material.
